(19) United States
(12) Patent Application Publication
(10) Pub. No.: US 2019/0236960 A1
(43) Pub. Date: Aug. 1, 2019

(54) INFORMATION PROCESSING DEVICE, STORAGE MEDIUM STORING INFORMATION PROCESSING PROGRAM, AND INFORMATION PROCESSING METHOD

(71) Applicant: Toyota Jidosha Kabushiki Kaisha, Toyota-shi Aichi-ken (JP)

(72) Inventors: Shin Sakurada, Toyota-shi Aichi-ken (JP); Tomoya Suzuki, Toyota-shi Aichi-ken (JP); Hideo Hasegawa, Nagoya-shi Aichi-ken (JP); Takao Hishikawa, Nagoya-shi Aichi-ken (JP)

(73) Assignee: Toyota Jidosha Kabushiki Kaisha, Toyota-shi Aichi-ken (JP)

(21) Appl. No.: 16/259,200

(22) Filed: Jan. 28, 2019

(30) Foreign Application Priority Data
Jan. 29, 2018 (JP) 2018-012426

(51) Int. Cl. G08G 1/00; G06F 21/31; G01C 21/34; H04W 4/40; H04W 4/021

(52) U.S. Cl. CPC G08G 1/205; G06F 21/31; G06F 2221/2137; H04W 4/40; H04W 4/021; G01C 21/3438

(57) ABSTRACT

An information processing device includes a controller. The controller is configured to give temporary use authorization of a vehicle to a user. The controller is configured to receive a use end request to end using the vehicle from a terminal that the user having the temporary use authorization operates. The controller is configured to acquire current location information of the vehicle. The controller is configured to determine whether a location that is identified based on the current location information of the vehicle is in an inappropriate area. The controller is configured to, when the controller determines that the location is in the inappropriate area, provide the terminal with notification that the user is not allowed to end using the vehicle.

### CROSS-REFERENCE TO RELATED APPLICATION

This application claims priority to Japanese Patent Application No. 2018-012426 filed on Jan. 29, 2018, incorporated herein by reference in its entirety.

### BACKGROUND

### 1. Technical Field

The present disclosure relates to an information processing device, a storage medium storing an information processing program, and an information processing method.

### 2. Description of Related Art

When a vehicle is parked in a dangerous area, there is a high possibility of becoming a victim of theft, or the like. Japanese Unexamined Patent Application Publication No. 2011-085478 (JP 2011-085478 A) describers an in-vehicle electronic device. The in-vehicle electronic device allows a user to optionally register a desired point into data of theft-prone areas, and, when a location at which a vehicle is stopped is in any one of the theft-prone areas, cautions the user.

### SUMMARY

However, the technique described in JP 2011-085478 A is not made in consideration of a situation in which an owner of a vehicle allows another user to use the vehicle, that is, for example, car sharing or car rental.

Some aspects of the disclosure provide an information processing device, a storage medium storing an information processing program, and information processing method, which allow a user having temporary use authorization to suitably use a vehicle.

An aspect of the disclosure relates to an information processing device. The information processing device includes a controller. The controller is configured to give temporary use authorization of a vehicle to a user. The controller is configured to receive a use end request to end using the vehicle from a terminal that the user having the temporary use authorization operates. The controller is configured to acquire current location information of the vehicle. The controller is configured to determine whether a location that is identified based on the current location information of the vehicle is in an inappropriate area. The controller is configured to, when the controller determines that the location is in the inappropriate area, provide the terminal with notification that the user is not allowed to end using the vehicle.

An aspect of the disclosure relates to a storage medium storing an information processing program. The information processing program causes a computer to execute instructions for: receiving, from a server, authentication information for allowing a user having temporary use authorization to use a vehicle; transmitting, to the server, a use end request to allow the user to end using the vehicle; determining whether a location of the vehicle is in an inappropriate area; when the location is in the inappropriate area, receiving notification that the user is not allowed to end using the vehicle; and notifying the user that the user is not allowed to end using, the vehicle, in response to the notification that the user is not allowed to end using the vehicle.

An aspect of the disclosure relates to an information processing method. The information processing method includes: receiving, by a user terminal, from a server, authentication information for allowing a user having temporary use authorization to use a vehicle; transmitting, by the user terminal, to the server, a use end request to allow the user to end using the vehicle; determining, by the user terminal, whether a location of the vehicle is in an inappropriate area; when it is determined that the location is in the inappropriate area, receiving, by the user terminal, notification that the user is not allowed to end using the vehicle; and notifying, by the user terminal, the user that the user is not allowed to end using the vehicle, in response to the notification that the user is not allowed to end using the vehicle.

In the aspects of the disclosure, a unit or device does not merely mean a physical means, and includes a case where the function of the unit or device is implemented by software. The function of the unit or device is implemented by two or more physical means or devices. The functions of the two or more units or devices may be implemented by a physical means or device.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram that shows the functional configuration of a vehicle system according to an embodiment;

FIG. 2 is a flowchart that shows the flow of a process that is executed in the vehicle system shown in FIG. 1;

FIG. 3 is a flowchart that shows the flow of a process that is executed in the vehicle system shown in FIG. 1;

FIG. 4 is a flowchart that shows the flow of a process that is executed in the vehicle system shown in FIG. 1; and

FIG. 5 is a block diagram that shows a specific example of hardware configuration that is able to implement each of a server, a user terminal, and a vehicle, shown in FIG. 1.

### DETAILED DESCRIPTION

Hereinafter, an embodiment will be described with reference to the accompanying drawings. The embodiment that will be described below is only illustrative, and is not intended to exclude application of various modifications or techniques unless otherwise specified. Like reference numerals denote the same or similar portions in the drawings. The drawings are schematic, and do not necessarily reflect actual dimensions, ratios, or the like. There may be portions having a different relation or ratio in dimensions among the drawings.

### Embodiment

### 1 Functional Configuration

### 1.1 Overall Configuration

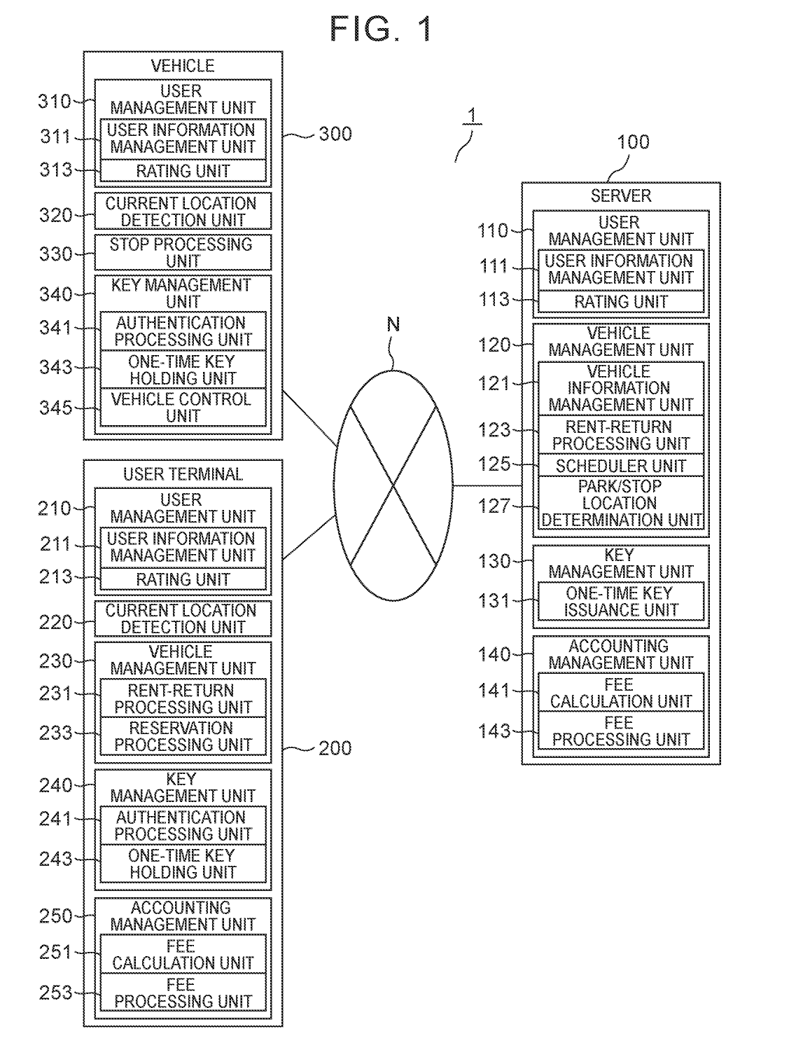

The functional configuration of a vehicle system 1 according to the present embodiment will be described with reference to FIG. 1. The vehicle system 1 includes a server 100, a user terminal 200, and a vehicle .300. The user terminal 200 is a terminal, such as a cellular phone, that a user operates. The server 100, the user terminal 200, and the vehicle 300 are communicable with one another via a network N, such as the Internet, a public telephone network, and a combination of the Internet and the public telephone network. The user terminal 200 and the vehicle 300 may be communicable with each other by near field communication. (NFC), such as Bluetooth (registered trademark), without intervening the network N. FIG. 1 shows only the single user terminal 200 and the single vehicle 300. Instead, a plurality of the user terminals 200 communicable with the server 100 may be provided, and a plurality of vehicles 300 communicable with the server 100 may be provided. The server 100 does not need to be physically implemented by a single information processing device. It is also conceivable that a plurality of information processing devices cooperatively implements the functions of the server 100.

The server 100 is a device for realizing a car sharing service or car rental service that temporarily rents one or more vehicles 300 registered in advance to a user and allows the user to use the one or more vehicles 300. At this time, the server 100 gives temporary use authorization to the user, and transmits, for example, authentication information to the user terminal 200 that the user operates. The authentication information is a key to use the vehicle 300. The user unlocks the vehicle 300 or starts up an engine or a motor by, for example, bringing the user terminal 200, having the downloaded authentication information, close to the vehicle 300. In the following description, the server 100 will be described as a device that offers car sharing service in the vehicle system 1. The server 100 may also be applied to car rental service with a similar mechanism.

### 1.2 Server 100

The functional configuration of the server 100 will be described. The server 100 includes a user management unit 110, a vehicle management unit 120, a key management unit 130, and an accounting management unit 140.

The user management unit 110 manages information about users who use the car sharing service. The user management unit 11.0 includes a user information management unit 111 and a rating unit 113.

The user information management unit 111 manages information about one or more users who are allowed to use the car sharing service. Examples of the user information that is managed by the user information management unit 111 include not only information, such as user's name and user's phone number, but also the identification information of the user terminal 200 to be used, service use history, accounting information, and rating information of the user. For a user who is currently renting out the vehicle 300, the user information management unit 111 may also manage information about the vehicle 300 being rented out and information, such as rental start time and scheduled rental end time.

The rating unit 113 updates and manages rating information of users. The rating unit 113, for example, in the car sharing service that is operated by a business operator, gives a high rating to a user who has performed a desirable use, and gives a low rating to a user who has performed an undesirable use. More specifically, for example, the rating unit 113 should lower a rating value that is managed in the rating information for users who have conducted activities, such as parking the vehicle 300 in an area in which theft, or the like, frequently occurs (hereinafter, referred to as inappropriate area), damaging the body of the vehicle 300, and leaving garbage at the time of return. On the other hand, the rating unit 113 should raise a rating value for users who repeatedly use the service without any inappropriate activities. Other than the above, for example, when a user has performed maintenance, such as replacement of tires of the vehicle 300 and refilling oil, the rating unit 113 may raise the rating value of the user.

Since the rating unit 113 manages the rating information of users in this way, it is possible to, for example, offer special incentives to users who have a high rating value; whereas it is possible to provide restrictions to uses who have a low rating. The special incentives are, for example, to allow users to rent expensive vehicles. The restrictions are, for example, to limit vehicle models or a time for which a vehicle is allowed to be rented.

The vehicle management unit 120 manages the rentable vehicles 300 in the car sharing service. The vehicle management unit 120 includes a vehicle information management unit 121, a rent-return processing unit 123, a scheduler unit 125, and a park/stop location determination unit 127.

The vehicle information management unit 121 manages information about one or more rentable vehicles 300 in the car sharing, service. Examples of the vehicle information that is managed by the vehicle information management unit 121 may include the identification information of each vehicle 300 and specifications information of each vehicle 300. Examples of the specifications information include vehicle model, piston displacement, and the number of available passengers. The vehicle information management unit 121 may also manage information about users currently using the vehicles 300, and information, such as rental start time and scheduled rental end time.

As the rent-return processing unit 123 receives a request from the user terminal 200 that a user operates, the rent-return processing unit 123 rents the vehicle 300 to the user, and executes a process for accepting a process of returning the vehicle 300 from the user. More specifically, at the time of renting the vehicle 300 to a user, the rent-return processing unit 123 gives temporary use authorization to the user, and causes the key management unit 130 to transmit authentication information that is a substitute for a key to the user terminal 200 and the vehicle 300. At the time of returning the vehicle 300 from the user, the rent-return processing unit 123 stops the temporary use authorization of the user, and causes the key management unit 130 to disable the use of the authentication information transmitted to the user terminal 200 and the vehicle 300.

The scheduler unit 125 manages the status of rental or rental schedule for each of the one or more vehicles 300 that are managed in the vehicle information management unit 121. More specifically, the scheduler unit 125 should manage, for example, which user the vehicle 300 is rented to or scheduled to be rented to from when to when for each vehicle 300.

The park/stop location determination unit 127 acquires location information from the vehicle 300 at the time of parking or stopping the vehicle 300, and determines whether the location is in a predetermined appropriate area. For example, when the rent-return processing unit 123 has detected that the user made a procedure to return the vehicle 300, the park/stop location determination unit 127 acquires the location information of the vehicle 300, and determines whether the vehicle 300 is in an appropriate area. If the park/stop location determination unit 127 determines that the vehicle 300 is in a theft-prone dangerous area or an area around a port where illegal export is induced, it is conceivable that the rent-return processing unit 123, for example, does not accept the procedure to return the vehicle 300. Alternatively, when the park/stop location determination unit 127 determines that a user frequently parks or stops the vehicle 300 in a dangerous area during use of the vehicle 300, it is conceivable that the rating unit 113 lowers the rating value of the user to reduce the use of the vehicle 300 by the user in a dangerous area. The key management unit 130, for example, manages authentication information for a user to use the vehicle 300. The key management unit 130 includes a one-time key issuance unit 131.

For example, at the time of giving temporary use authorization of the vehicle 300 to a user, the one-time key issuance unit 131 generates a one-time key to use the vehicle 300, and transmits authentication information including the one-time key to the user terminal 200 and the vehicle 300. The user terminal 200 executes an authentication process with the vehicle 300 using the authentication information. When the authentication process is successful, the user terminal 200 is allowed to, for example, unlock the vehicle 300 or start up the engine or motor.

At the time of accepting a procedure to return the vehicle 300 from a user, the one-time key issuance unit 131 should rewrite authentication information by transmitting a new one-time key to the vehicle 300, or should make the user not to be able to use the vehicle 300 with the user terminal 200 by invalidating the authentication information of the user terminal 200 and/or the vehicle 300.

The accounting management unit 140 executes an accounting process for charging a user who has rented the vehicle 300 through the car sharing service for a fee. The accounting management unit 140 includes a fee calculation unit 141 and a fee processing unit 143.

The fee calculation unit 141 calculates a fee for which a user is charged, in accordance with the vehicle model of the vehicle 300 rented by the user, a time for which the user has rented the vehicle 300, and the like. The fee processing unit 143, for example, executes an accounting process for the fee calculated by the fee calculation unit 141 with the use of a fee charging method registered by the user in advance (for example, payment information of a credit card, deduction information from a bank account, or the like). At this time, it is conceivable that the fee processing unit 143 provides notification about the fee for which the user is charged, the fee processing method, and the like, to the user terminal 200.

### 1.3 User Terminal 200

Next, the functional configuration of the user terminal 200 will be described. The user terminal 200 includes a user management unit 210, a current location detection unit 220, a vehicle management unit 230, a key management unit 240, and an accounting management unit 250.

The user management unit 210 manages information about a user who uses the user terminal 200. The user management unit 210 includes a user information management unit 211 and a rating unit 213.

The user information management unit 211 manages information about the user who uses the user terminal 200. Examples of the user information that is managed by the user information management unit 211 include not only information, such as user's name and user's phone number, but also the identification information of the user terminal 200, service use history, accounting information, and rating information of the user. The user information management unit 211 is able to correct the user information that is managed by the user information management unit 111 of the server 100 and bring both pieces of user information into coincidence with each other by carrying out communication with the server 100 as needed. The user information management unit 211 does not need to store or manage the user information on the user terminal 200. The user information management unit 211 may, for example, update or display the user information by carrying out communication with the server 100 as needed.

The rating unit 213 updates and manages rating information that is the rating of the user who uses the user terminal 200 in using the car sharing service. The rating unit 213, for example, in the car sharing service, gives a high rating to a user who has performed a desirable use, and gives a low rating to a user who has performed an undesirable use. The rating unit 213 may be configured to be able to update the rating information that is managed by the server 100 by carrying out communication with the server 100 as needed.

The current location detection unit 220 acquires the current location of the user terminal 200 based on, for example, information from a global positioning system (GPS), information from a surrounding Wi-Fi, and the like. The current location information detected by the current location detection unit 220 may be transmitted to the server 100 where necessary.

The vehicle management unit 230 manages the vehicle 300. That is, for example, the vehicle management unit 230 allows the user to rent the vehicle 300 or return the rented vehicle 300. The vehicle management unit 230 includes a rent-return processing unit 231 and a reservation processing unit 233.

The rent-return processing unit 231 executes a process for accepting a process of renting the vehicle 300 to the user and returning the vehicle 300 from the user in response to user's operation. More specifically, at the time of renting the vehicle 300 to the user, the rent-return processing unit 231 makes a request of the server 100 to give temporary use authorization, and causes the key management unit 240 to execute, for example, an authentication process that is a substitute for a key. At the time of returning the vehicle 300 from the user, the rent-return, processing unit 231 makes a request of the server 100 to stop temporary use authorization of the user. If the return is admitted, the rent-return processing unit 231 may cause the key management unit 240 to, for example, make a request to invalidate authentication information that is a substitute for a key. The reservation processing unit 233 transmits reservation for getting the rental vehicle 300 to the server 100 in response to user's operation, or the like.

The key management unit 240, for example, manages authentication information for the user to use the vehicle 300. The key management unit 240 includes an authentication processing unit 241 and a one-time key holding unit 243.

At the time of getting issuance of authentication information that is a substitute for a key, the authentication processing unit 241 executes an authentication process with the server 100. When the authentication process by the authentication processing unit 241 is successful, the one-time key holding unit 243 receives authentication information including a one-time key from the server 100, and holds the authentication information. When the user uses the vehicle 300, the authentication processing unit 241 executes an authentication process with the vehicle 300 with the use of the authentication information. When the authentication process is successful, the user is allowed to, for example, unlock the vehicle 300 or start up the engine or motor. When the user returns the vehicle 300, the one-time key holding unit 243 should delete or invalidate the authentication information that is a substitute for a key based on a request from the server 100.

The accounting management unit 250 executes an accounting process for charging the user who has rented the vehicle 300 through the car sharing service for a fee. The accounting management unit 250 includes a fee calculation unit 251 and a fee processing unit 253.

The fee calculation unit 251, in cooperation with the fee calculation unit 141 of the server 100, calculates a fee for which the user is charged, in accordance with the vehicle model of the vehicle 300 rented by the user, a time for which the user has rented the vehicle 300, and the like. The fee processing unit 253, in cooperation with the fee processing unit 143 of the server 100, executes an accounting process for the fee calculated by the fee calculation unit 251 with the use of the fee charging method registered by the user in advance. At this time, the fee calculation unit 251 may inform the user of, for example, the fee for which the user is charged, the fee processing method, and the like.

### 1.4 Vehicle 300

Next, the functional configuration of the vehicle 300 will be described. The vehicle 300 is, for example, an automobile that runs while loading a user. The vehicle 300 is bilaterally communicable with the server 100 via the network N that is, for example, the Internet, a public telephone network, or the like. The vehicle 300 and the user terminal 200 may be provided so as to be communicable with each other via, for example, near field communication (NFC), or the like. The vehicle 300 includes a user management unit 310, a current location detection unit 320, a stop processing unit 330, and a key management unit 340.

The user management unit 310 manages information about a user who uses the vehicle 300 and a user who owns the vehicle 300. The user management unit 310 includes a user information management unit 311 and a rating unit 313.

The user information management unit 311 manages information about a user who uses the vehicle 300 and a user who owns the vehicle 300. Examples of the user information that is managed by the user information management unit 311 include not only information, such as user's name and user's phone number, but also the identification information of the user terminal 200, service use history, accounting information, and rating information of the user. The user information management unit 311 is able to correct the user information that is managed by the user information management unit 111 of the server 100 or the user information management unit 211 of the user terminal 200 and bring both pieces of user information into coincidence with each other by carrying out communication with the server 100 or the user terminal 200 as needed. The user information management unit 311 does not need to directly store or manage user information on the vehicle 300. The user information management unit 311 may, for example, update or display user information by carrying out communication with the server 100 or the user terminal 200 as needed.

The current location detection unit 320 acquires the current location of the vehicle 300 based on, for example, information from the GPS or the surrounding Wi-Fi. The current location information detected by the current location detection unit 320 is transmitted to the server 100 where necessary.

The stop processing unit 330 executes a process of stopping the vehicle 300 in response to user's driving operation. At this time, the stop processing unit 330 acquires current location information with the use of the current location detection unit 320. That is, the stop processing unit 330 detects the park/stop location of the vehicle 300, and transmits the park/stop location to the server 100 where necessary. Thus, the server 100 is able to determine whether the vehicle 300 is parked or stopped in an inappropriate area.

The key management unit 340, for example, manages authentication information for a user to use the vehicle 300. The key management unit 340 includes an authentication processing unit 341, a one-time key holding unit 343, and a vehicle control unit 345.

When the authentication processing unit 341 gets issuance of authentication information substitute for a key, the authentication processing unit 341 executes an authentication process with the server 100. When the authentication process by the authentication processing unit 341 is successful, the one-time key holding unit 343 receives authentication information including a one-time key from the server 100, and holds the authentication information. When the user uses the vehicle 300, the authentication processing unit 341 executes an authentication process with the user terminal 200 with the use of the authentication information. When the authentication process is successful, the vehicle control unit 345, for example, unlocks or starts up the engine or the motor in response to user's operation.

### 2 Flow of Process

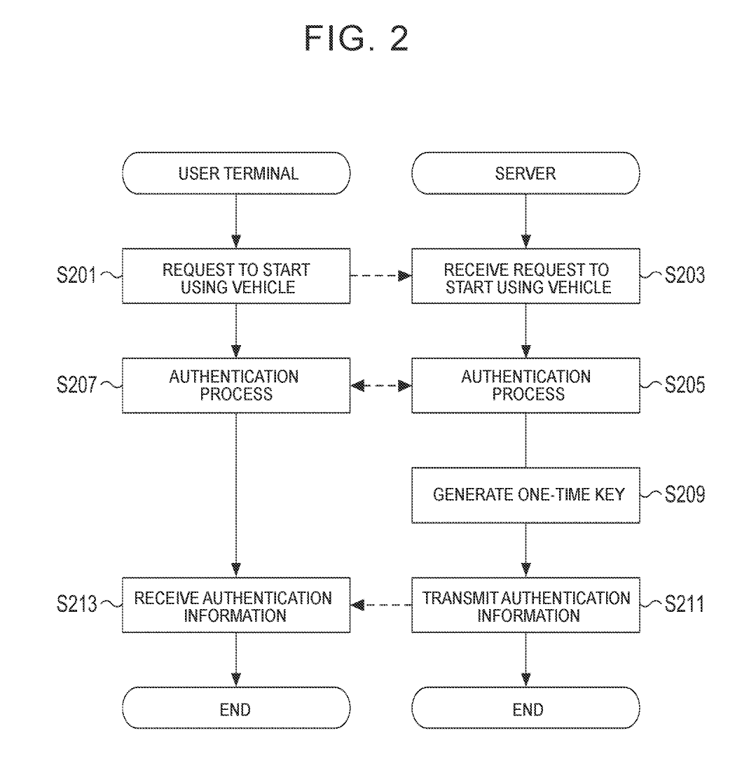

Hereinafter, the flow of a process that is executed by the vehicle system 1 will be described with reference to FIG. 2 to FIG. 4. FIG. 2 to FIG. 4 are flowcharts that show the flows of processes that are executed by the server 100, user terminal 200, and vehicle 300 that constitute the vehicle system 1.

Processing steps (described later) may be executed in a selected order or in parallel without any contradiction in processing details, and an additional step may be added between the processing steps. A step described as a single step for the sake of convenience may also be executed as a plurality of separated steps. Steps described in a plurality of separated steps for the sake of convenience may also be executed as a single step.

### 2.1 Flow of Process at Time of Renting Out Vehicle 300

Hereinafter, the flow of a process at the time of renting the vehicle 300 to a user will be described with reference to FIG. 2. FIG. 2 is a flowchart that shows the flow of the process that is executed by the server 100 and the user terminal 200 at the time renting the vehicle 300 to a user.

As the user operates the user terminal 200 to conduct a procedure to start using the vehicle 300, the rent-return processing unit 231 of the user terminal 200 makes a request of the server 100 to start using the vehicle 300, that is, to set temporary use authorization (S201).

As the rent-return processing unit 123 of the server 100 receives a request to start using the vehicle 300 from the user terminal 200 (S203), the rent-return processing unit 123 makes a request of the one-time key issuance unit 131 of the key management unit 130 for an authentication process. The one-time key issuance unit 131 of the server 100 and the user terminal 200 execute the authentication process in cooperation with each other (S205 and S207). When the authentication is successful, the user information management unit 111 of the server 100 sets temporary use authorization for the user. The one-time key issuance unit 131 generates a one-time key (S209), and transmits authentication information including the one-time key to the user terminal 200 (S211). The server 100 is also able to transmit the authentication information to the vehicle 300.

As the one-time key holding unit 243 of the user terminal 200 receives the authentication information (S213), the one-time key holding unit 243 stores the authentication information in an internal storage area. The user terminal 200 executes the authentication process in cooperation with the vehicle 300 with the use of the authentication information. When the authentication process is successful, the user terminal 200 is able to unlock the vehicle 300 or start up the engine or motor.

### 2.2 Flow of Process at Time of Returning Vehicle 300

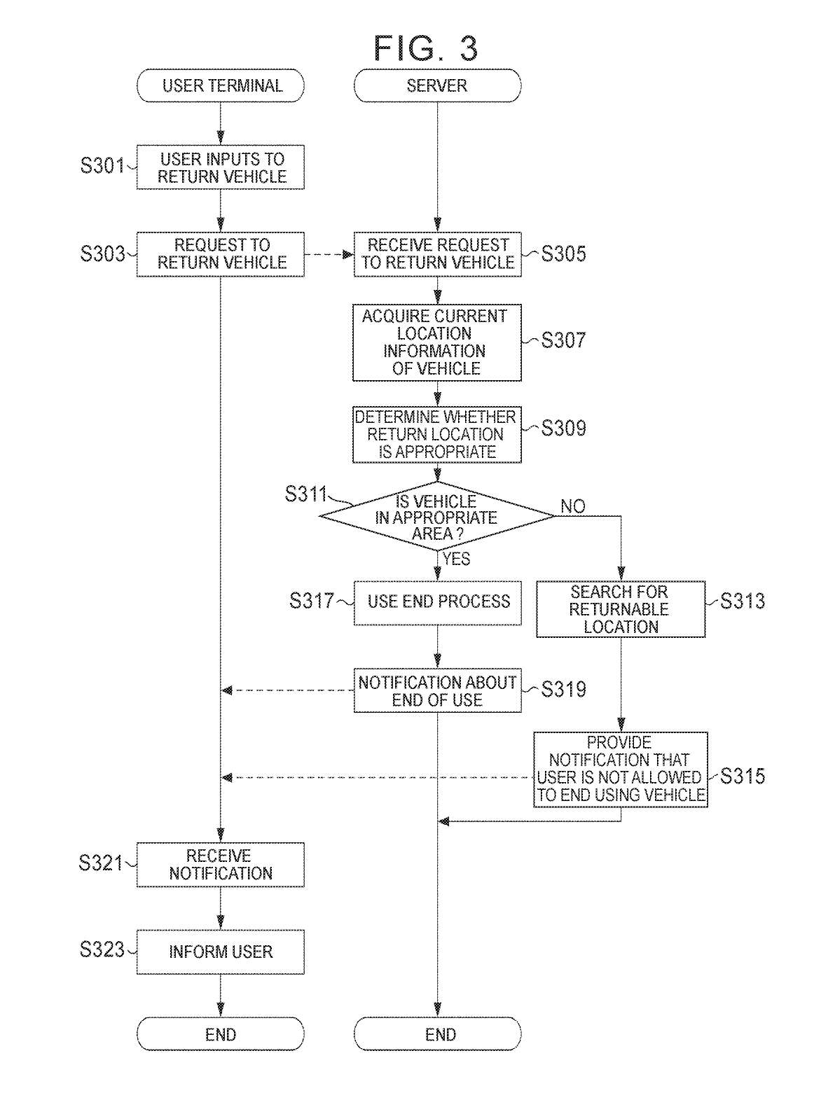

Next, the flow of a process at the time returning the vehicle 300 from a user to which the vehicle 300 has been rented will be descried with reference to FIG. 3. FIG. 3 is a flowchart that shows the flow of the process that is executed by the server 100 and the user terminal 200 at the time of returning the vehicle 300 from a user.

As the user operates the user terminal 200 to conduct a procedure to return the vehicle 300 (S301), the rent-return processing unit 231 of the user terminal 200 makes a request of the server 100 to return (end using) the vehicle 300, that is, to stop the set temporary use authorization (S303).

As the rent-return processing unit 123 of the server 100 receives a request to return the vehicle 300 (use end request) from the user terminal 200 (S305), the park/stop location determination unit 127 acquires the current location information of the vehicle 300 (S307). The park/stop location determination unit 127 determines whether the current location of the vehicle 300 is not in a predetermined inappropriate area or whether the current location of the vehicle 300 is in an appropriate area (S309). As a result, if the park/stop location determination unit 127 determines that the vehicle 300 is in the inappropriate area or the vehicle is not in the appropriate area (No in S311), the rent-return processing unit 123 searches for a returnable location that is located near the current location of the vehicle 300 and that is not in the inappropriate area (that is in the appropriate area) (S313). Then, the rent-return processing unit 123 provides information about the returnable location to the user terminal 200 together with information that the user is not allowed to return (end using) the vehicle 300 at the current location of the vehicle 300 (S315).

Alternatively, when the park/stop location determination unit 127 determines in S311 that the vehicle 300 is not in the inappropriate area, that is, the vehicle 300 is in the appropriate area (Yes in S311), the rent-return processing unit 123 executes various processes to end using the vehicle 300, that is, for example, the rent-return processing unit 123 makes a request of the user information management unit 111 to stop temporary use authorization or makes a request of the key management unit 130 to invalidate authentication information issued for the user to use the vehicle 300 (S317). Then, the rent-return processing unit 123 provides the user terminal 200 with notification about the normal end of use (S319).

As the rent-return processing unit 231 of the user terminal 200 receives the notification about the end of use (S321), the rent-return processing unit 231 executes the process of, for example, invalidating authentication information by the key management unit 240 where necessary, and informs the user of the end of use (S323).

### 2.3 Flow of Process of Rating User Based on Park/stop Location

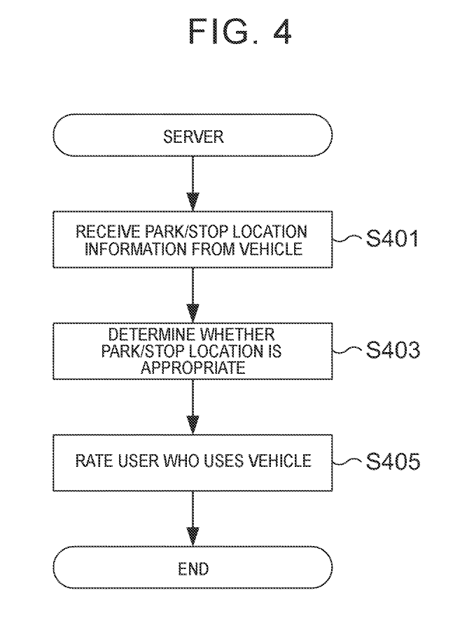

Hereinafter, the flow of a process of rating a user based on a park/stop location will be described with reference to FIG. 4. FIG. 4 is a flowchart that shows the flow of the process that is executed by the server 100 at the time of rating a user based on a park/stop location.

As the server 100 receives information about a park/stop location from the vehicle 300 (S401), the park/stop location determination unit 127 of the server 100 determines whether the park/stop location is appropriate (S403). The rating unit 113 rates a user by, for example, raising the rating value of the user when the park/stop location is in an appropriate area (the park/stop location is not in an inappropriate area) and lowering the rating value of the user when the park/stop location is not in the appropriate area (the park/stop location is in the inappropriate area) (S405).

### 3 Hardware Configuration

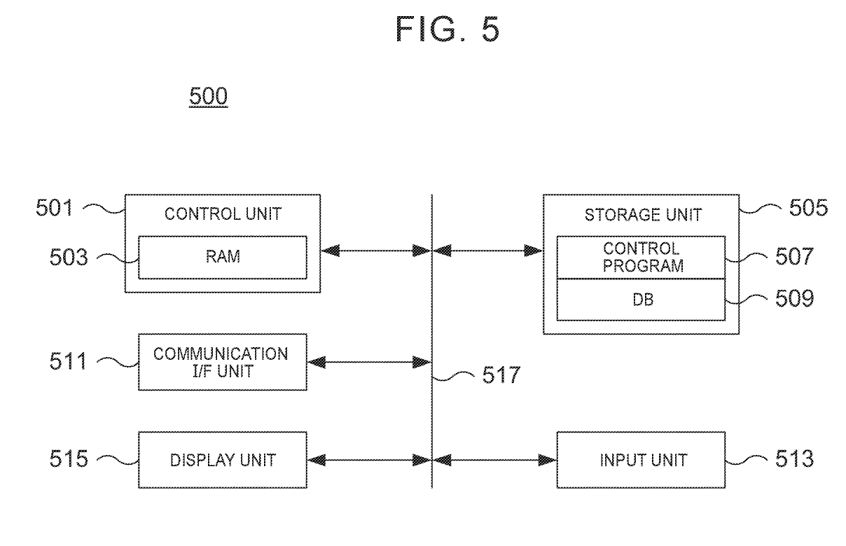

The hardware configuration of a computer 500 that is able to implement each of the server 100, the user terminal 200, and the vehicle 300 will be described with reference to FIG. 5. The computer 500 includes a control unit 501, a storage unit 505, a communication interface (I/F) unit 511, an input unit 513, and a display unit 515. The units are connected to one another via a bus line 517.

The control unit 501 includes a central processing unit (CPU) (not shown), a read only memory (ROM) (not shown), a random access memory (RAM) 503, and the like. The control unit 501 is configured to be able to execute processes associated with the components of the server 100, user terminal 200, and vehicle 300, shown in FIG. 1 in addition to the functions of a general computer by executing a control program 507 stored in the storage unit 505. For example, the user management unit 110, vehicle management unit 120, key management unit 130, and accounting management unit 140 of the server 100 may be implemented as the control program 507 that runs on the CPU after the control program 507 is temporarily stored in the RAM 503. This also applies to the user management unit 210, current location detection unit 220, vehicle management unit 230, key management unit 240, and accounting management unit 250 of the user terminal 200, and the user management unit 310, current location detection unit 320, stop processing unit 330, and key management unit 340 of the vehicle 300.

The RAM 503 temporarily stores part or all of codes included in the control program 507 and part or all of pieces of information that is managed by a DB 509. The RAM 503 is also used as a work area at the time when the CPU executes various processes.

The storage unit 505 is a nonvolatile storage medium, such as a hard disk drive (HDD) and a flash memory. The storage unit 505 stores the control program 507 and the DB 509. The control program 507 includes an operating system (OS) and application programs for implementing the functions of a general computer. The DB 509 manages required information. The communication I/F unit 511 is a device for carrying out wireless or wired data communication among the server 100, the user terminal 200, and the vehicle 300 where necessary.

The input unit 513 is a device for accepting an input operation from a user. Specific examples of the input unit 513 may include various buttons, a touch panel, a microphone, and a keyboard.

The display unit 515 is a display device for providing various pieces of information to a user who operates the computer 500. Specific examples of the display unit 515 may include a liquid crystal display and an electro-luminescence (EL) display.

### 4 Advantageous Effects of Present Embodiment

As described above, in the vehicle system 1 according to the present embodiment, when a user conducts a procedure to return the vehicle 300, it is determined whether the location of the vehicle 300 is not in an inappropriate area, and, when the location of the vehicle 300 is in the inappropriate area, the user is not allowed to return the vehicle 300. Thus, it is possible to prevent the vehicle 300 from becoming a victim of theft, or the like, as a result of, for example, dropping off the vehicle 300 in a dangerous inappropriate area. Even not at the time of returning the vehicle 300, it is determined whether a location at which a user parks or stops the vehicle 300 is in an inappropriate area, and, for example, parking or stopping the vehicle 300 in an inappropriate area is reduced by changing the rating value of the user based on the determined result. Thus, it is possible to prompt a user to use the vehicle 300 in an appropriate area.

### 5 Adding

The above-described embodiment is intended to easily understand the disclosure, and is not intended to interpret the disclosure in a limited way. Elements of the embodiment, and the arrangement, materials, conditions, shapes, sizes, and the like, of the elements are not limited to the illustrated ones, and may be modified as needed. Components described in different embodiments may be partially replaced or may be combined.

What is claimed is:

1. An information processing device comprising a controller configured to:
give temporary use authorization of a vehicle to a user,
receive a use end request to end using the vehicle from a terminal that the user having the temporary use authorization operates,
acquire current location information of the vehicle,
determine whether a location that is identified based on the current location information of the vehicle is in an inappropriate area, and
when the location is in the inappropriate area, provide the terminal with notification that the user is not allowed to end using the vehicle.

2. The information processing device according to claim 1, wherein:
the controller is configured to transmit authentication information to the terminal that the user having the temporary use authorization operates; and
the controller is configured to transmit the authentication information to the vehicle which the user is allowed to use.

3. The information processing device according to claim 2, wherein:
the controller is configured to, when the controller determines that the location that is identified based on the current location information of the vehicle is not in the inappropriate area, stop the temporary use authorization set for the user; and
the controller is configured to provide notification about the stop of the temporary use authorization to the vehicle.

4. The information processing device according to claim 1, wherein the controller is configured to provide a stop location, which is outside of the inappropriate area and which the vehicle is recommended to stop, to the terminal together with notification that the user is not allowed to end using the vehicle.

5. The information processing device according to claim 1, wherein:
the controller is configured to acquire a stop location at which the vehicle stops, from the vehicle; and
the controller is configured to update rating information of the user in accordance with the stop location.

6. The information processing device according to claim 5, wherein the controller is configured to change service that is offered to the user, in accordance with the rating information.

7. A nonvolatile storage medium storing an information processing program, the information processing program causing a computer to execute instructions for:
receiving, from a server, authentication information for allowing a user having temporary use authorization to use a vehicle;
transmitting, to the server, a use end request to allow the user to end using the vehicle;
determining whether a location of the vehicle is in an inappropriate area;
when the location is in the inappropriate area, receiving notification that the user is not allowed to end using the vehicle; and
notifying the user that the user is not allowed to end using the vehicle, in response to the notification that the user is not allowed to end using the vehicle.

8. The nonvolatile storage medium according to claim 7, wherein the program further causes the computer to execute instructions for:
when it is determined that the location of the vehicle is not in the inappropriate area, receiving notification that the temporary use authorization of the vehicle is stopped; and
notifying the user that the user is not allowed to end using the vehicle, in response to the notification that the temporary use authorization is stopped.

9. An information processing method comprising:
receiving, by a user terminal, from a server, authentication information for allowing a user having temporary use authorization to use a vehicle;
transmitting, by the user terminal, to the server, a use end request to allow the user to end using the vehicle;
determining, by the user terminal, whether a location of the vehicle is in an inappropriate area;
when it is determined that the location of the vehicle is in the inappropriate area, receiving, by the user terminal, notification that the user is not allowed to end using the vehicle; and
notifying, by the user terminal, the user that the user is not allowed to end using the vehicle, in response to the notification that the user is not allowed to end using the vehicle.
